(19) United States
(12) Patent Application Publication
(10) Pub. No.: US 2004/0249767 A1
(43) Pub. Date: Dec. 9, 2004

(54) System and method for fleet card management

(75) Inventor: Donald R. Perrin, Vienna, VA (US)

Correspondence Address: FINNEGAN, HENDERSON, FARABOW, GARRETT & DUNNER, LLP, 1300 I STREET, NW, WASHINGTON, DC, 20005, US

(73) Assignee: United States Postal Service

(21) Appl. No.: 10/859,571

(22) Filed: Jun. 3, 2004

Related U.S. Application Data
(60) Provisional application No. 60/475,247, filed on Jun. 3, 2003.

(51) Int. Cl. G06F 17/60

(52) U.S. Cl. 705/64

(57) ABSTRACT

System and method for managing purchase data of a credit card account associated with a vehicle in a fleet through the use of a management system. The management system receives transaction data from a credit card system and organizes the transaction data into a sortable listing for viewing by a user. The sortable listing may indicate a probability of fraud. The management system downloads data regarding a vehicle from home station. The management system may also provide invoices to a financial department for payment of the transactions.

### RELATED APPLICATION

The present invention is related to and claims priority of U.S. Provisional Application No. 60/475,247 filed Jun. 3, 2003, in the name of Donald PERRIN, and titled PURCHASE CARD MANAGEMENT, the contents of which are fully incorporated herein by reference.

### DESCRIPTION

### TECHNICAL FIELD

This invention relates generally to managing credit cards accounts, and more particularly, managing the accounting and use of credit cards for vehicles delivering packages.

### BACKGROUND

In business today, postal delivery services use vehicles to delivery packages to customers. The vehicles may belong to a fleet of vehicles, in which each vehicle may originate from a home station. In addition, the home station may be part of a larger network of vehicles. For example, the United States Postal Service (USPS) contains a fleet of vehicles. Each vehicle may be primarily domiciled at a home station and each home station may belong to a vehicle maintenance facility (VMF) or a vehicle post office (VPO), which is also known as a VMAS (Vehicle Maintenance Accounting System) Location Code. Expanding the network, each VMF or VPO may belong to a district and each district may belong to a business area (BA). In the USPS, each BA may further belong to an area. For example, BA 1A (the New York Metro P&D) and BA 4A (the New York Metro CSAO) both belong to Area A (New York Metro). In addition, each vehicle may have an associated finance number. Today, the USPS has 11 Areas, 85 Districts, 191 VMFs and VPOs, and nearly 8,000 Finance Numbers.

The postal delivery service incurs costs for the day-to-day operation of delivery vehicles such as gasoline and oil and may also incur maintenance costs such as repairs on the vehicle. Drivers of the vehicles may purchase such goods and services for the vehicle on behalf of the delivery service. However, when the number of vehicles in a fleet is large, monitoring and tracking the costs for operation and maintenance becomes increasingly difficult. This may increase the likelihood of mismanagement of resources and funds directed to the operation of the vehicle. This may also increase the likelihood of not detecting instances of fraud.

Thus, it is desirable to provide a management system that monitors and manages credit cards for the use of operation and maintenance costs for vehicles in a fleet and allows for efficiently and tracking the incurred costs.

### SUMMARY

In accordance with the invention, there is provided a method for managing a credit card account associated with a vehicle. The method comprises sending transaction data regarding a credit card account to a management system; downloading data regarding information on each vehicle associated with a home station; organizing the transaction data to provide a sorted listing of the transaction data associated with each vehicle; and formatting the sorted listing for viewing over an Internet web page.

Also provided is a system for managing a credit card account associated with a vehicle. The system comprises a management system; a credit card system; and a home station. The credit card system provides the management system with transaction data associated with the credit card account. The management system downloads identifying information associated with the vehicles from the home station, organizes the transaction data into a sortable list associated with the vehicle, and displays the sortable listing over an Internet web page.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is flowchart for a method 100 showing the tasks and steps for managing a credit card account.

FIG. 2 illustrates a system consistent with the present invention.

FIG. 3 illustrates a computer screen shot for an Internet home page consistent with the present invention.

FIG. 4 illustrates a computer screen shot for an invoice report consistent with the present invention.

FIG. 5 illustrates a computer screen shot for a product summary consistent with the present invention.

### DESCRIPTION OF THE EMBODIMENTS

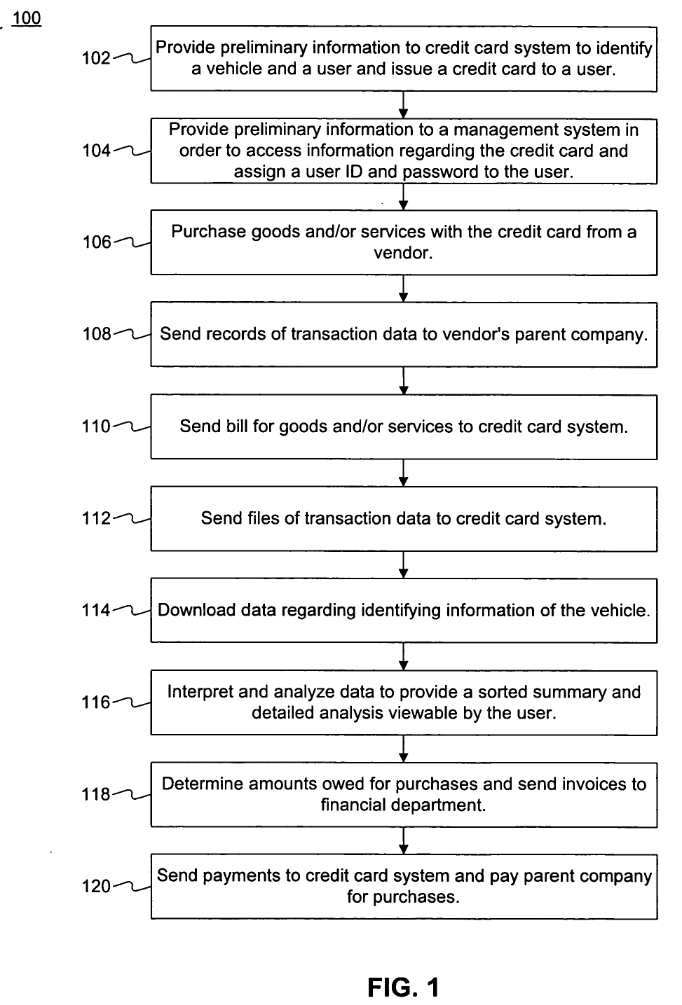

FIG. 1 is a flowchart for a method 100 showing the tasks and steps for managing a credit card account.

Method 100 begins at stage 102 where a user, such as a driver for a postal delivery vehicle, provides preliminary information to a credit card system in order for the credit card system to issue a credit card and account on behalf of the user. The preliminary information may serve to identify the user and the vehicle. The preliminary information may include a seven (7) digit vehicle identification number, the vehicle's BA, district, VMAS location, home station, and finance number. Changes to the preliminary information may also be sent to the credit card system. The credit card system issues a credit card to the user based upon the preliminary information.

At stage 104, the user, or any authorized person desiring to access information regarding the management of the credit card account, may also provide preliminary information to a management system, which includes a management database and server. The preliminary information may be a request for computer access. The user may be assigned a user identification (User ID) and a password in order to access the account. For example, users may be allowed to view information of the account regarding the finance number, district, and BA submitted at stage 102. Users may also be able to access information for more than one finance number.

At stage 106, the user may purchase goods and services using the credit card from a vendor. The user may provide a personal identification number (PIN), which may be separate from the user ID and password, to use the credit card. The PIN may be used to identify the user. The goods and services may be related to the operation and/or maintenance of the delivery vehicle. For example, the user may purchase gasoline or oil. The user may also procure repair work for the vehicle.

At stage 108, the vendor sends records of transaction data, related to the purchase of goods and/or services by the user, to a parent company of the vendor.

At stage 110, the parent company may send a bill for goods and/or services to the credit card system.

At stage 112, the credit card system sends the transaction data related to the purchase to the management system. The data may include details of credit card transactions that the credit card system received during a specified time period, for example, a week. The information may be sent in a secure manner (e.g., through a firewall) to the management server and loaded into the management database.

At stage 114, the management system may also download information from a master database which may be identifying information about the vehicle. The master database may contain a record of all the vehicles, and each vehicle's home station, district, location, and finance number.

At stage 116, the management system may interpret and analyze the transaction data and provide a sorted summary of the transaction data in a format that is readable by the user. The management system may also provide detailed entries of the transaction data. For example, the database may summarize or sort the data by vehicle, driver, supplier, and type of product or service purchased (e.g., fuel, oil, washing, repairs, and miscellaneous). The users may view the summary data and detailed data in a manner suitable to the needs of the user. In addition, users may access the information at any time during method 100.

At stage 118, the management system may determine the amounts owed for the credit card purchases and may send invoices to a financial department for payment of the outstanding balances.

At stage 120, the financial department may send payments to the credit card system for payment to the parent company.

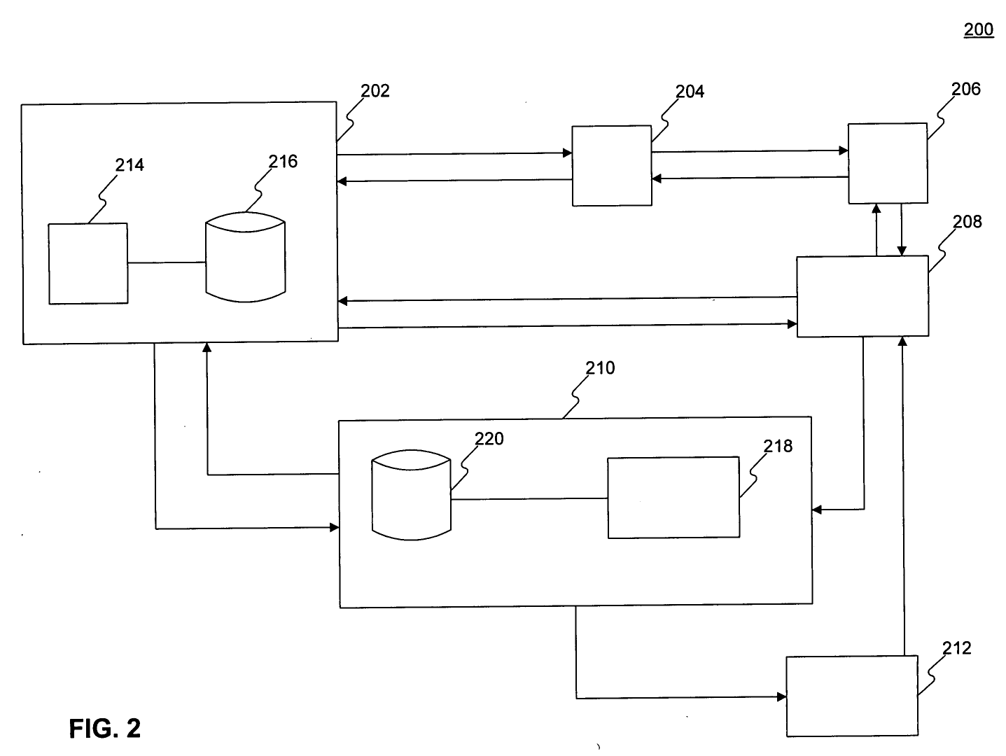

FIG. 2 illustrates a system 200 for management of a credit card. System 200 includes home station 202, vendor 204, parent company 206, credit card system 208, management system 210, and financial department 212. Home station may further include computer 214 and database 216. Management system 210 may further include server 218 and database 220.

Home station 202 may include vehicles that are primarily stationed in one area. Users in home station 202 may use computer 214 to supply preliminary information to credit card system 208 and management system 210, as described above in connection with FIG. 1.

Once the user receives a credit card, the user may use the credit card to purchase goods and/or services from vendor 204. Vendor 204 sends the charge to parent company 206, which sends a bill to credit card system 208.

Credit card system 208 sends transaction information of the credit card to management system 210. Server 218 receives the transaction data. The transaction data may be received through a firewall to ensure security and integrity of the transmission. The transaction data is in a form that is machine readable, but not easily readable by the user.

The transaction data is stored in database 220, which also stores information relating to database 216. Database 216 may be a local database that stores all the vehicle maintenance and accounting information for all the vehicles within home station 202.

Management system 210 interprets and analyzes the transaction data to convert the transaction data into a human-readable format. Management system may also summarize and/or sort the transaction data by different fields which may be used by the user to view the data.

For example, database 220 may provide the transaction data to the user in twenty-seven (27) tables that may be viewed on a Internet web screen. The twenty-seven (27) tables may be classified into six (6) different categories, including, detail tables, summary tables, reference tables, security tables, temporary load tables, and load status tables.

Detail tables may include six (6) different tables including the following: product detail tables, discount tables, payment adjustment tables, invoice tables, load master tables, and customer status tables.

Product tables may contain detailed data about every transaction that is charged to the credit card. The data may be provided in a form of one (1) row for every different product purchased.

Discount tables may contain data on discounts that the postal delivery service may receive from vendors when those discounts are not included as part of an individual credit card transaction. For example, discounts negotiated with vendors may not take effect until a minimum amount has been purchased over a certain time period and the vendor may give a discount for purchases above a certain amount per month.

Payment adjustment tables may contain data regarding adjustments made to credit card purchases. For example, adjustments may include adjustments for taxes for which the postal delivery service may be exempt, discounts, and transaction reversals and corrections.

Invoice tables may include detailed data of invoices created by management system 210 and sent to financial department 212.

Load master tables may contain data from header records from loads by credit card system 208. Customer status tables may contain data from trailer records from loads by credit card system 208. Header and trailer records may represent indicators that divide data from one account to another account (e.g., to compartmentalize or separate data associated with different accounts in different areas). The data may be in the form of weekly or monthly listing. The customer status table may contain record counts and totals for each load. The data may be used to report and validate invoice totals.

Summary tables may include four (4) different tables including a product summary table, a vehicle summary table, a driver summary table, and a station summary table. These tables are explained in greater detail below.

The product summary table may contain summaries for the total amounts that were charged for various products and services, such as, fuel, oil, washing, repairs, miscellaneous charges, adjustments, and exempt taxes. The summaries in the product summary table may include totals for each month and year-to-date totals. The summaries in the product summary table may be stored by finance number, area, district, location, and station

The vehicle summary table may contain each vehicle's identification number (vehicle ID) and summaries of the total amounts that each vehicle charged for various products and services, such as fuel, oil, washing, repairs, miscellaneous charges, adjustments, and exempt taxes. The summaries in the vehicle summary table may include totals for each Month and year-to-date totals.

The driver summary table may include names of drivers and summaries for the total amounts that each driver charged for various products and services, such as fuel, oil, washing, repairs, miscellaneous charges, adjustments, and exempt taxes. The summaries in the driver summary table may include totals for each Month and year-to-date totals.

The station summary table may contain summaries for each supplier's parent company name and summaries of the total amounts of each product purchased from the supplier. The totals include total units purchased, total amount charged, average unit cost, number of transactions, total exempt taxes, and total amount invoiced for each Month.

The reference tables may include five (5) different types of tables, including, a master reference table, a duplicate master reference table, a values table, a vehicle maintenance and accounting (VMAS) dropdown table, and a VMAS mini-master table. These tables are explained in greater detail below.

The master reference table may contain an identification number and name of each finance number, BA, district, station, and location. A use of the master reference table may be to look up a name of a finance number or organizational unit to display on a Internet web screen. The master reference table may also be the basis for a dropdown list.

The duplicate reference table may be a copy of a reference table in a financial data mart (FDM) system and may be used to update the master reference table

The values table may contain various codes that are used in other tables, along with a code identifying a type of code (such as a product code or a vendor code) and a description of a meaning of the code.

The VMAS dropdown table may contain the data that is used to display a dropdown list of organizational units that may appear under a VMAS view on an Internet webpage for managing the credit card account.

The VMAS mini-master table may contain data about each vehicle, such as the vehicle's finance number, home area, district, VMAS location code, disposal date, and date of storage. The data is obtained from a VIC database and may be refreshed weekly. The VIC database may be a listing of information that identifies each vehicle. The data in the VMAS mini-master table may be responsible for determining which finance number is charged with the credit card associated with each vehicle.

The temporary load tables may include seven (7) tables that may be used during load processing. The seven (7) tables may facilitate loading of data into table previously described above. The temporary load tables may serve as temporary holding tables for data transferred from credit card system 208 to be later transferred to management system 210. The seven (7) tables include a temporary detail table, a temporary driver summary table, a temporary product summary table, a temporary station summary table, a temporary vehicle summary table, a temporary driver work table, and temporary vehicle work table.

The temporary detail table may contain detailed transaction data received from the credit card system. When the load processing is completed and the all the transaction data has been received by the temporary detail table, the data may be transferred to the product detail table.

The temporary driver summary table may contain summary data for each driver. Management system 210 may calculate summary data by summing data in the temporary detail table by driver. When all the load processing steps have been successfully completed, the data in the temporary driver summary table may be transferred to the driver summary table.

The temporary product summary table may contain summaries of the total amounts that were charged for various products and services, such as fuel, oil, washing, repairs, miscellaneous charges, adjustments, and exempt taxes. Management system 210 may calculate the summary data by summing data in the temporary detail table by the driver. When all the load processing steps have been completed, the data in the temporary product summary table may be transferred to the product summary table.

The temporary station summary table may contain summary data for each supplier. Management system 210 may calculate the summary data by summing data in the temporary detail table by supplier. When the load processing steps have been completed, the data in the table may be moved into the station summary table.

The temporary vehicle summary table may contain summary data for each vehicle. Management system 210 calculates the summary data by summing data in the temporary detail table by vehicle. When all the load processing steps are completed, the data in the temporary vehicle summary table is transferred into the vehicle summary table.

The temporary driver work table and the temporary vehicle work table are tables that are temporary storage locations for received load data. Using the temporary driver work table and temporary vehicle work table may allow the loading to process more quickly and efficiently.

Load status tables may include three (3) tables that may indicate the status or progress of data being loaded during the load processes as described above. The three (3) tables include a database status table, a load log table, and a load progress table.

The database status table may contain a single column, which may be set to “1” when a load is in progress or set to “0” at other times. The purpose of the database status table may be prevent more than one load process from running at the same time. The database status table may also lock out users from a web screen when the load process is transferring data from temporary tables to permanent tables at the end of the load process.

The load log table may contain a sequence listing of all the activities that take place for raw data to be loaded into management system 210. If an error or failure occurs in any step for the loading activities, a user may determine at which step the error or failure occurred using the load log table.

The load progress table may contain messages that load procedures associated with management system 210 may write out to document results of the load processing. The message, which may indicate completion when processing is successful, explain errors when processing fails, and provide an audit trail for people who may support management system 210.

Management system 210 may load both weekly and monthly files from credit card system 208 and a file extracted from the VIC database. For example, a VIC extract file may be manually downloaded weekly (e.g., every Friday after 8:00 pm). The VIC extract file may be loaded into management system 210 automatically every week after the VIC extract file is downloaded. A weekly file located in credit card system 208 may be loaded automatically on a weekly basis (e.g., every Saturday afternoon). Every week the weekly file of credit card system 208 may be processed automatically (e.g., every Saturday at 10:00 pm) and automatically loaded into management system 210 every month. The process of automatic loading may implemented using an Oracle PL/SQL program.

The management system 210 may be accessible through an Internet connection and web page designed for the user (e.g., the driver or another authorized person) to access information regarding the credit card account. This allows users to gain access to transactions processed by the credit card system (e.g. credit card system 208). The users may view summary data in a variety of different ways and may access detailed information regarding individual transactions.

In addition, the management system (e.g., management system 210) may issue User IDs and passwords that may specify the business areas, finance numbers, and districts for which each user may view data regarding the credit card account.

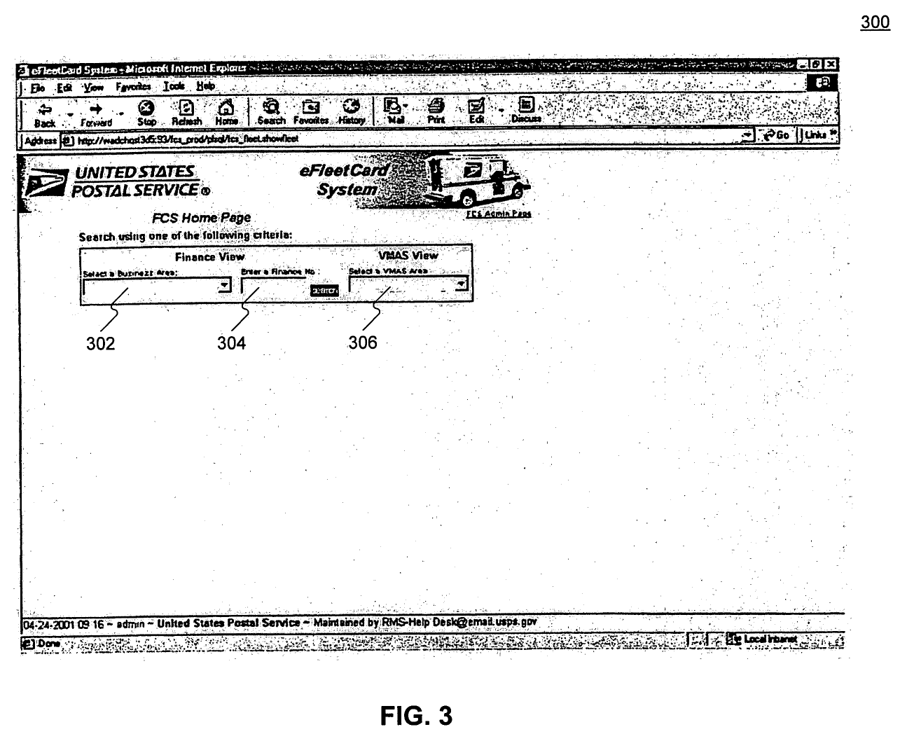

FIG. 3 shows an illustrative screen shot of an Internet home page 300 consistent with the present invention. Screen shot 300 includes a drop down lists 302, 304, and 306.

Internet page 300 may be accessed after the successful login of a user's User ID and password. The user may view data in different ways, including by business area, finance number, and VMAS area. List 302 may correspond to business area, list 304 may correspond to finance number, and list 306 may correspond to VMAS area. Each drop down list offers the user choices in each of the different views.

For example, to specify a business area, a user may click on the drop-down list under a “Select a Business Area” heading. The system may display a number of different business areas. If one of the business areas is selected, the system may display a list of organizational units with the selected BA. Further, once an organizational unit is selected, a list of accounting periods may be displayed for the user to select.

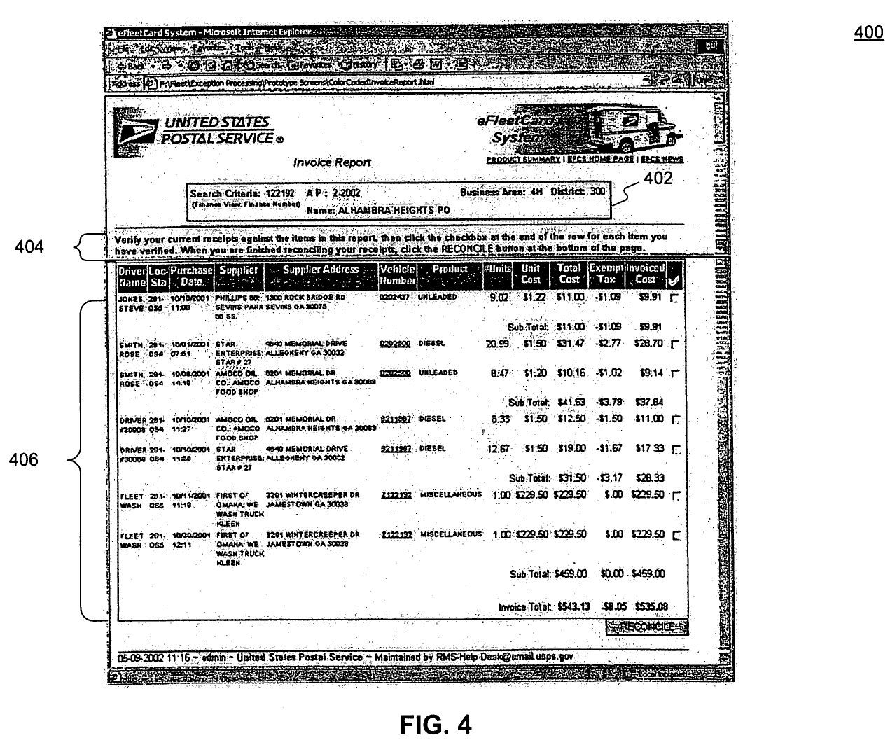

The management system may also offer the user a number of pages in order to view detailed views of the transactional data. For example, FIG. 4 illustrates a screen shot of a an invoice report 400. Invoice report 400 includes identification field 402, headings 404, and data 406.

Identification field 402 may include information such as the business area, district, name, search criteria, and Month that identifies the invoice report. Headings 404 may be a driver's name, a local station, a purchase date, a supplier, a supplier address, a vehicle number, a product, a quantity of units, a unit cost, a total cost, a exemption amount for taxes, and an invoiced cost. Data 406 corresponds to headings 404 showing the detailed data for business area 4H and district 300.

Invoice report 400 may also indicate exceptions through color coding. An exception may be a transaction that is flagged for a possible instance of fraud or misuse of the credit card or possible errors in the use of the credit card. Possible instances of fraud may include, using the card for personal use items such as food. Possible errors may include display of conflicting goods such as unleaded fuel and diesel fuel for the same vehicle.

Data 406 may be displayed with different colors depending a likelihood of fraud. Red color entries may indicate a velocity exception, which may be an exception with a high probability of fraud. Blue color entries may indicate authorization exceptions, which may be exceptions with an average probability of fraud. Purple color entries may indicate usage exceptions, which may be exceptions with a low probability of fraud. Green color entries may indicate finance number exceptions, which may be exceptions that have an incorrect finance number associated with the transaction. Each transaction with a color coded exception may further have a vehicle number hyperlink, which the user may click on to view specific exceptions that may have occurred with the vehicle.

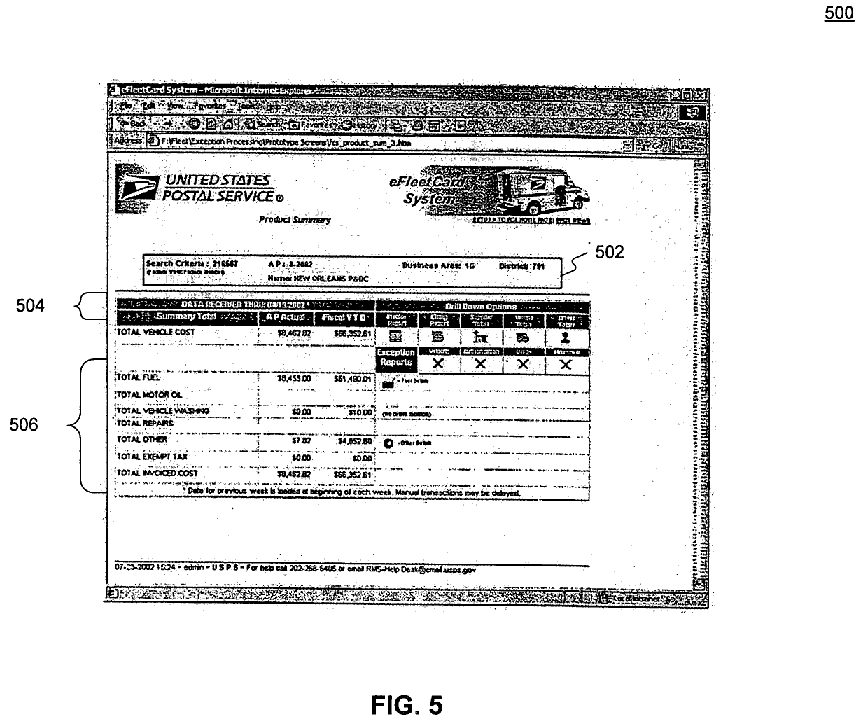

FIG. 5 illustrates a screen shot of a product summary 500. Product summary 500 includes identifying information field 502, headings 504, and data 506.

Identifying information 502 may identify basic information to which product summary 500 pertains. For example, product summary 500 regards a search criteria 216567, Month 8-2002, business area 1G, district 701, and a name of New Orleans P&DC. Headings 504 shows different fields such as a summary total, Month actual cost, a year to date cost, and drill down options. Drill down options may allow the user to view more detailed analysis of the transaction data, including an invoice report, billing report, supplier tools, vehicle totals, driver totals, and exception reports for the exceptions previously described. Data 506 corresponds to headings 506 and shows summary details and cost figures.

Product summary 500 may provide links to show exception reports for selected vehicles. For example, by clicking on a red “X,” a user may all velocity exceptions, by clicking on a blue “X,” the user may access authorization exceptions, by clicking on a purple “X,” the user may access usage exceptions, and by clicking on a green “X,” the user may access finance number exceptions. The user may be directed to a separate screen which lists all the transactions corresponding to the exceptions.

Management system 210 may also provide other screens for the user to view data regarding transactions on the credit card account.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for managing a credit card account associated with a vehicle comprising:
sending transaction data regarding a credit card account to a management system;
downloading data regarding information on each vehicle associated with a home station;
organizing the transaction data to provide a sorted listing of the transaction data associated with each vehicle; and
formatting the sorted listing for viewing over an Internet web page.

2. The method of claim 1, further comprising providing the management system with identifying information for issuance of a user ID and password in order to access the sorted listing.

3. The method of claim 2, wherein the user ID and password allow access to information associated with the provided identifying information.

4. The method of claim 1, further comprising sending an invoice to a financial department based upon the transaction data.

5. The method of claim 4, further comprising sending payment associated with the invoice to a credit card system for payment to at least one of a vendor and a parent company.

6. The method of claim 1, further comprising:
providing information to a credit card company identifying a driver and the vehicle; and
issuing a credit card account associated with the vehicle to the user.

7. The method of claim 1, further comprising:
displaying the sorted listing according to data located in at least one of a detailed table, a summary table, a reference table, a security table, a temporary load table, and a load status table in the management system.

8. The method of claim 1, further comprising:
displaying the sorted listing on an Internet web page, wherein the sorted listing is viewable by at least one of vehicle, driver, supplier, and type of product purchased.

9. A system for managing a credit card account associated with a vehicle, comprising:
a management system;
a credit card system; and
a home station;
wherein the credit card system provides the management system with transaction data associated with the credit card account;
wherein the management system downloads identifying information associated with the vehicles from the home station, organizes the transaction data into a sortable list associated with the vehicle, and displays the sortable listing over an Internet web page.

10. The system of claim 9, wherein the management system includes a server for receiving the transaction data and a database for storing the transaction data and the identifying information associated with the vehicle.

11. The system of claim 10, wherein the server receives the transaction data through a firewall.

12. The system of claim 9, further comprising a financial department; wherein the management system sends invoices to the financial department; and
the financial department sends payment associated with the invoice to the credit card system for payment to at least one of a vendor and a parent company.

13. The system of claim 10, wherein the management system issues a user ID and password associated with supplied information for access to the Internet web page.

14. The system of claim 10, wherein the sortable list is displayed to according to data located in a detailed table, a summary table, a reference table, a security table, a temporary load table, and a load status table in the management system.

15. The system of claim 10, wherein the sortable listing is displayed on an Internet web page by at least one of vehicle, driver, supplier, and type of product purchased.
